(19) United States
(12) Patent Application Publication
(10) Pub. No.: US 2015/0158370 A1
(43) Pub. Date: Jun. 11, 2015

(54) STEERING WHEEL WITH ACTIVE VENTILATION DEVICE AND METHOD FOR PRODUCING A STEERING WHEEL

(71) Applicant: GM GLOBAL TECHNOLOGY OPERATIONS LLC, Detroit, MI (US)

(72) Inventors: Carsten GLASER, Muehltal (DE); Kyriakos KALLIDIS, Trebur (DE); Markus FISCHER, Buettelborn (DE)

(73) Assignee: GM GLOBAL TECHNOLOGY OPERATIONS LLC, Detroit, MI (US)

(21) Appl. No.: 14/097,715

(22) Filed: Dec. 5, 2013

(30) Foreign Application Priority Data
Dec. 5, 2013 (DE) 10 2012 023 777.4

(51) Int. Cl. B60H 1/24; B62D 1/04; B29C 44/12

(52) U.S. Cl. CPC B60H 1/246; B29C 44/12; B62D 1/04; B29K 2105/04

(57) ABSTRACT

A steering wheel is provided with an active ventilation device, in particular for a motor vehicle, which includes, but is not limited to a fan arrangement with a fan with which ambient air can be sucked in through at least one air inlet opening of the steering wheel, one air duct for conducting air to at least one air outlet opening of the steering wheel. At least one of these air ducts is formed as a hollow space in a foam element of the steering wheel.

### CROSS-REFERENCE TO RELATED APPLICATION

This application claims priority to German Patent Application No. 10 2012 023 777.4, filed Dec. 5, 2012, which is incorporated herein by reference in its entirety.

### DESCRIPTION

The technical field relates to a steering wheel with an active ventilation device, in particular for a motor vehicle, and to a method for producing a steering wheel with active ventilation device.

### BACKGROUND

Steering wheels are known, in particular steering wheels for motor vehicles. In particular at high or low ambient temperatures or intensive solar radiation, an interior of a motor vehicle can heat up or cool down in such a manner that the operating surfaces of the steering wheel of the motor vehicle have a high or low temperature. This temperature can be perceived as irritating and/or painful by the driver of the motor vehicle.

For this reason steering wheels have already been proposed in which an air circulation takes place for cooling the operating surfaces of the steering wheel. Frequently, such steering wheels are connected to the existing ventilation system of the motor vehicle. Steering wheels with integrated fan have already been proposed as well.

In view of the foregoing, at least one object is to provide an improved steering wheel with an active ventilation device, in particular for a motor vehicle. While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

### SUMMARY

A steering wheel is provided with an active ventilation device, in particular for a motor vehicle, and comprises a fan arrangement with at least one, in particular one, two or three fans, with which ambient air can be sucked in through at least one, in particular one, two, three or a multiplicity of air inlet openings of the steering wheel. Such a steering wheel also comprises at least one, in particular one, two, and three or a plurality of air ducts for conducting air to at least one, in particular a multiplicity of air outlet openings of the steering wheel. At least one, in particular a plurality of or all of these air ducts are formed as hollow space in one or two or a plurality of foam elements of the steering wheel.

These air ducts in this case are defined in particular through this hollow space in the foam element and in particular do not comprise a separate component for bounding the air duct vis-a-vis the foam element, other components of the steering wheel and/or the surroundings. Because of this configuration, the production of the steering wheel can be in particular advantageously simplified, rendered beneficial and/or accelerated. Likewise, the functional safety of a ventilation of the steering wheel can be advantageously improved. A weight saving can also be advantageously achieved.

These air ducts can also be partially defined by this hollow space in the foam element and partially be defined through inner surfaces of an outer boundary element of the steering wheel and/or through outer surfaces of an element of a support structure. A hollow space in a foam element of the steering wheel in terms of this description is to mean in particular a macroscopic hollow space, which is not based on the porous nature of the foam, of which the foam element is formed.

In particular, in order to restrict adaptations for the integration of an active ventilation on components of the steering wheel advantageously as much as possible to foam elements of the steering wheel, the steering wheel comprises at least one support structure according to an embodiment. Air is conducted within the steering wheel in at least one air duct outside this support structure. Because of this configuration, a larger dimensioning of the support structure for receiving an air ducting can in particular be advantageously avoided.

A support structure of the steering wheel is to mean in particular elements for the in particular rigidly formed connection of the steering wheel to the steering column, steering wheel spoke structures connected with these and steering wheel rim structures connected with the steering wheel spoke structures. Such elements of a support structure are in particular formed of metallic materials such as aluminum and/or steel.

In particular, in order to facilitate the production of the steering wheel, a cross section of this hollow space according to an embodiment is bounded in a first circumferential region by the foam element and in a second circumferential region by a support structure of the steering wheel or by an outer boundary element of the steering wheel. This provides a simpler configuration of the mold for the foaming process during the production of the steering wheel can be achieved.

In order to in particular advantageously achieve a weight reduction of the steering wheel and/or minimize an undesirable heat transfer from metallic elements of the support structure to the conducted air, at least one, in particular all air ducts formed as macroscopic hollow space are spatially spaced at least in portions, in particular over the entire extension, from a support structure of the steering wheel according to an embodiment. In terms of this embodiment, in particular foam is arranged between the air duct and the support structure in a design thus spaced.

In particular, in order to advantageously improve the air ducting within the steering wheel at least one of these air ducts based on a cross section through a steering wheel rim of the steering wheel has a substantially annular cross section according to an embodiment. Air ducts with a substantially annular cross section can in particular be arranged in the circumferential regions of the steering wheel rim, on which the steering wheel rim is connected to a spoke of the steering wheel. With such an arrangement, further air ducts in particular such emanating from this air duct can then extend on the one hand along this spoke and on the other hand in circumferential direction of the steering wheel rim.

In particular in order to advantageously make possible a simple construction of the steering wheel, the steering wheel according to an embodiment comprises a foam element, which is arranged substantially surrounding the support structure of the steering wheel. The air ducts of the steering wheel are arranged in this foam element.

Here, an air duct can be considered arranged in the foam element when it is defined by a macroscopic hollow space running in the foam element, which exclusively comes to the surface of the foam element on the air outlet opening side and air inlet opening side; but in particular also when the macroscopic hollow space is arranged over a portion or over the entirety of its longitudinal extension on a surface of the foam element.

In particular in order to minimize the weight of the steering wheel, the foam element according to an embodiment comprises a recess. A fan of the fan arrangement is arranged in this recess. In terms of this embodiment, a fan each can be arranged decentralized in two or three recesses. Additionally or alternatively, a fan, in particular in such a recess, can be arranged centrally and/or in a hub of the steering wheel. If exclusively a fan is arranged in the hub of the steering wheel, the mass moment of inertia of the steering wheel with respect to the rotation of the steering wheel can be in particular advantageously minimized.

In particular, in order to advantageously ensure an air stream to the hands of a user of the steering wheel, air, according to an embodiment, can be conducted from this fan through at least one, in particular all air ducts to at least one, in particular a multiplicity of air outlet openings arranged in a steering wheel rim of the steering wheel. Alternatively, with otherwise identical arrangement, air can also be conductable from air inlet openings on the steering wheel rim to this fan in order to in particular advantageously route a stream of heated air on the steering wheel surface away from the hands of the user.

In particular in order to improve a cooling of portions of the steering wheel which are particularly greatly exposed to the solar radiation, an outer boundary element of the steering wheel according to an embodiment comprises a plurality of air outlet openings, which are arranged in particular on the outside of the steering wheel. Here, the outside of the steering wheel is to mean in particular the side of the steering wheel hub facing the driver, the entire surface of the steering wheel spokes and/or the entire surface of the steering wheel rim. In particular, at least one, in particular all air inlet openings according to an embodiment comprise a protective device, in particular a protective grille. Here, a protective device means in particular a component that prevents an occupant of the vehicle reaching into an air duct and/or a fan. A protective device formed as a protective grille can in particular comprise at least one metallic material and/or at least one plastic material.

In particular in order to make possible a supply of warm air to the driver's hands, the protective device according to an embodiment of the invention comprises a heating device, in particular at least one heating wire. This provides a heating function of the steering wheel can also be achieved in particular in addition to the ventilation operation without heating, which because of the air circulation automatically has a cooling effect.

According to an embodiment, a motor vehicle comprises a steering wheel according to one of the embodiments described above.

According to an embodiment, a method for producing a steering wheel with an active ventilation device. This method includes, but is not limited to: a mold for foaming a foam element of the steering wheel is produced, and in this mold at least one mold element is arranged, which makes possible forming at least one air duct formed as hollow space in this foam element for conducting air in this foam element, and a foam element of the steering wheel with at least one of the hollow spaces is cast. This provides a simply constructed and/or operational steering wheel can be made available particularly in an advantageous manner.

In an embodiment of the method, a mold element is arranged in such a manner that the hollow space thereby created during the casting at least in portions runs along a boundary surface of the foam element so that a cross section of this portion is only bounded part-circumferentially by foam mass. This provides a cost-effective mold for foaming the foam element can be in particular advantageously used.

### BRIEF DESCRIPTION OF THE DRAWINGS

The present invention will hereinafter be described in conjunction with the following drawing figures, wherein like numerals denote like elements, and:

FIG. 1 is a foamed steering wheel with air outlet openings on the spokes according to an embodiment;

FIG. 2 is a foam steering wheel with air outlet openings on the steering wheel rim according to an embodiment in a perspective rear view;

FIG. 3 is a further foam steering wheel with air outlet openings on the steering wheel rim according to an embodiment in a partially sectioned, lower view;

FIG. 4 is a detail of a foam steering wheel with air outlet openings on the steering wheel rim according to an embodiment in a sectional view through steering wheel rim and spoke; and

FIG. 5 is a detail of a foam steering wheel with an air duct abutting the support structure according to an embodiment in a sectional view through steering wheel rim and spoke.

### DETAILED DESCRIPTION

The following detailed description is merely exemplary in nature and is not intended to limit application and uses. Furthermore, there is no intention to be bound by any theory presented in the preceding background or summary or the following detailed description.

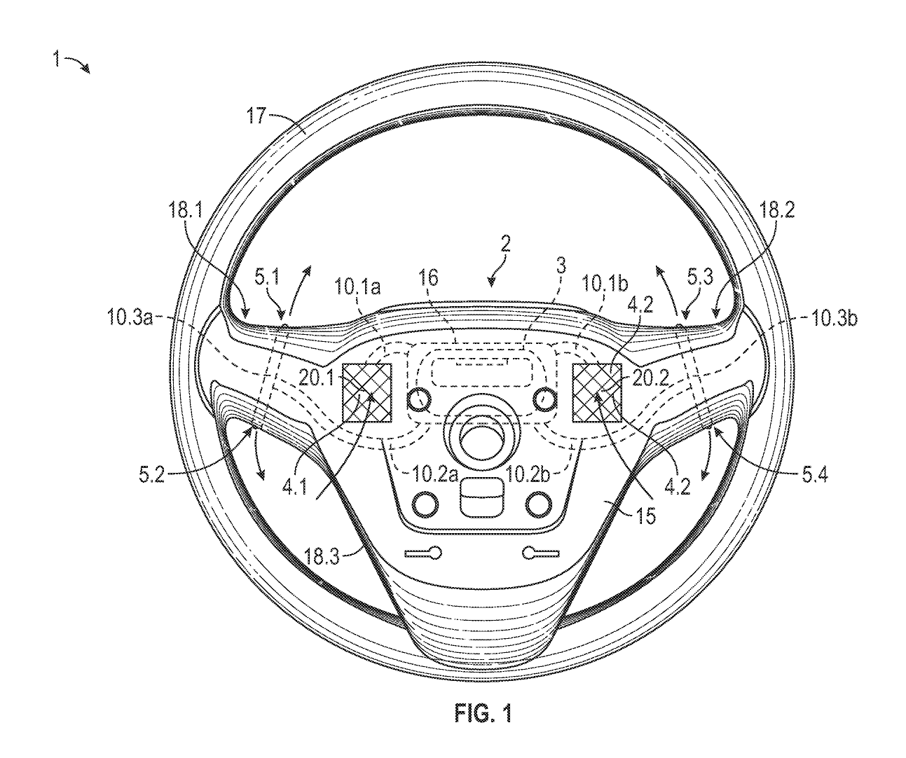

FIG. 1 shows a foamed steering wheel 1 with air outlet openings 5 on the spokes 18 according to an embodiment in a perspective rear view. The steering wheel 1 comprises two air inlet openings 4, which are each covered with a protective grille 20. The air inlet openings 4 are each connected by means of an air duct 10.1 to the recess 16 in the one-piece foam element 6 of the steering wheel 1.

In the recess 16, the fan 3 of the fan arrangement 2 is arranged and installed in a fixed manner. By means of this fan 3, air is sucked out of the air inlet openings 4 through the intake air ducts 10.1. Through the spoke air ducts 10.2, this air is conducted further to the distributor air ducts 10.3, where they are routed to the air outlet openings 5. All air ducts 10.1, 10.2 and 10.3 are foamed into the one-piece foam element 6 as hollow spaces. They do not comprise a separate boundary element; its walls are or will be rather formed by the foam surrounding them. This applies also to the recess 16. From the air outlet openings 5, air in the operating state of the fan 3 flows out of the steering wheel 1 into the vehicle interior, where it can cool or if applicable also warm the hands of the user. In all figures, the arrows which are not marked with reference characters explain in particular a flow direction of the air into the, in the and out of the steering wheel.

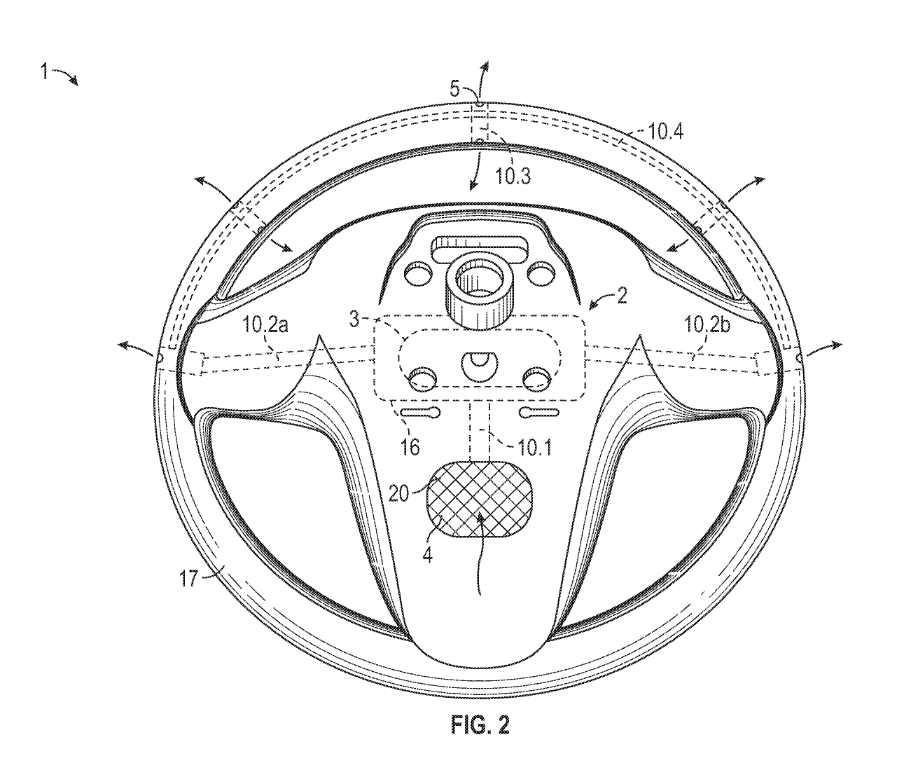

FIG. 2 shows a foam steering wheel 1 with air outlet openings 5 on the steering wheel rim 17 according to an embodiment in a perspective rear view. This embodiment, in addition to the restriction to an air inlet opening 4 with a protective grille 20 merely differs from the embodiment described in FIG. 1 through the arrangement of the air outlet openings 5 on the steering wheel rim 17. From the fan 3, the air is conducted via spoke air ducts 10.2, distributor air ducts 10.3 and steering wheel rim air ducts 10.4 to a multiplicity of air outlet openings 5, which are arranged on the steering wheel rim 17.

In this embodiment, all air ducts 10.1, 10.2, 10.3 and 10.4 are also foamed as hollow spaces into the one-piece foam element 6. They do not have a separate boundary element; its walls are or will be rather formed by the foam surrounding them. In this embodiment, the steering wheel 1 comprises a multiplicity of distributor air ducts 10.3 and air outlet openings 5, not only the five air ducts 10.3 shown.

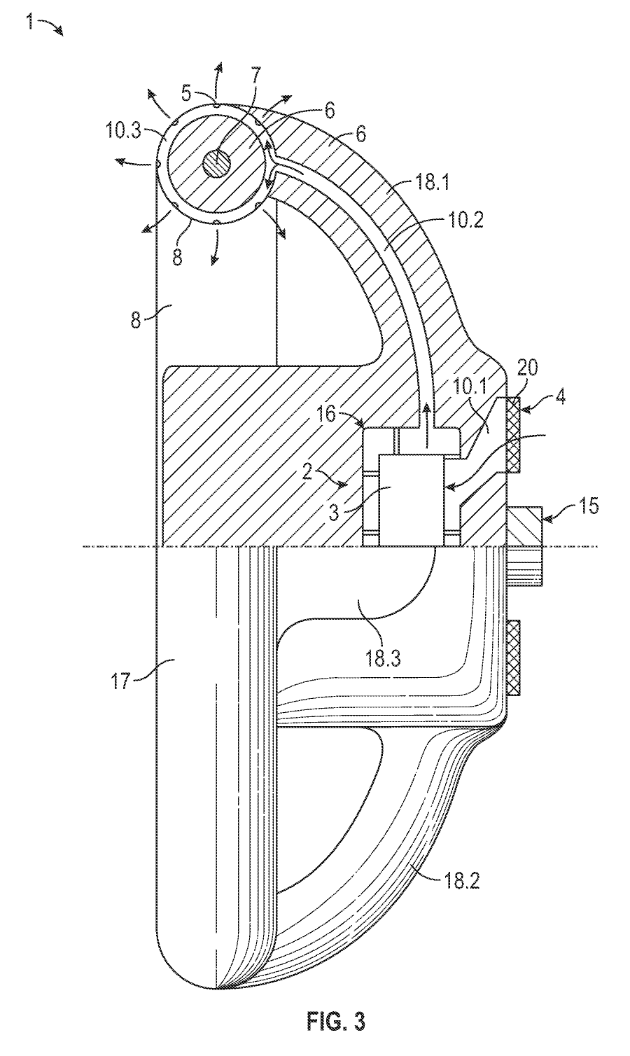

FIG. 3 shows a further foam steering wheel 1 with air outlet openings 5 on the steering wheel rim 17 according to an embodiment in a partially sectioned, lower view. In FIG. 3, the steering wheel 1 is shown below the dash-dotted line in a lower plan view; above the dash-dotted line sectioned through a horizontal plane at the height of the connection to the further steering elements of the vehicle. The embodiment according to FIG. 3 substantially shows the configuration of the air outlet openings 5 according to FIG. 2 connected to the configuration of the air inlet openings 4 according to FIG. 1, in each case schematically represented.

In FIG. 3, the route of the air sucked in by the rotating fan 3 through the protective grille 20 of the air inlet opening 4 and the intake air duct 10.1 into the recess 16 is clearly shown by an arrow. Having passed through the fan 3, the air is pressed into the spoke air duct 10.2 and from there enters the distributor air duct 10.3. This distributor air duct 10.3 is arranged in the steering wheel rim 17 and as a circular hollow space radially arranged between the foam element 6 and an outer boundary element 8 of the steering wheel formed as a grip element. The grip element 8 comprises a plurality of air outlet openings 5 in the region of the distributor air ducts 10.3, through which the air can flow out of the steering wheel into the vehicle interior.

FIG. 4 shows a detail of a foamed steering wheel 1 with air outlet openings 5 on the steering wheel rim according to an embodiment of the present invention in a sectional view through steering wheel rim 17 and spoke 18. The steering wheel comprises a support structure 7 a solid ring in the steering wheel rim 17, whereas the spoke 18 is embodied without elements of a support structure purely as part of the foam element 6.

Within this part of the foam element 6, a spoke air duct 10.2 designed as a hollow space is arranged, in which air is conducted from the fan which is not shown to an annular distributor air duct 10.3 in the steering wheel rim 17. From this annular distributor air channel 10.3, a part of the introduced air intentionally escapes via the plurality of air outlet openings 5 into the surroundings.

Another part of the introduced air is conducted through the steering wheel rim air duct 10.4 further to other distributor air ducts. The steering wheel rim air duct 10.4 in this case is formed as a partially exposed hollow space running on the surface of the foam element 6. The steering wheel rim air duct 10.4 in FIG. 4 extends out of the drawing plane into the sheet. The cross section of this steering wheel rim air duct 10.4 bounded by the foam element 6 only in a first circumferential portion 11 is bounded in a second circumferential portion 12 by the grip element 8 of the steering wheel rim 17, as a result of which a practical air ducting is made possible.

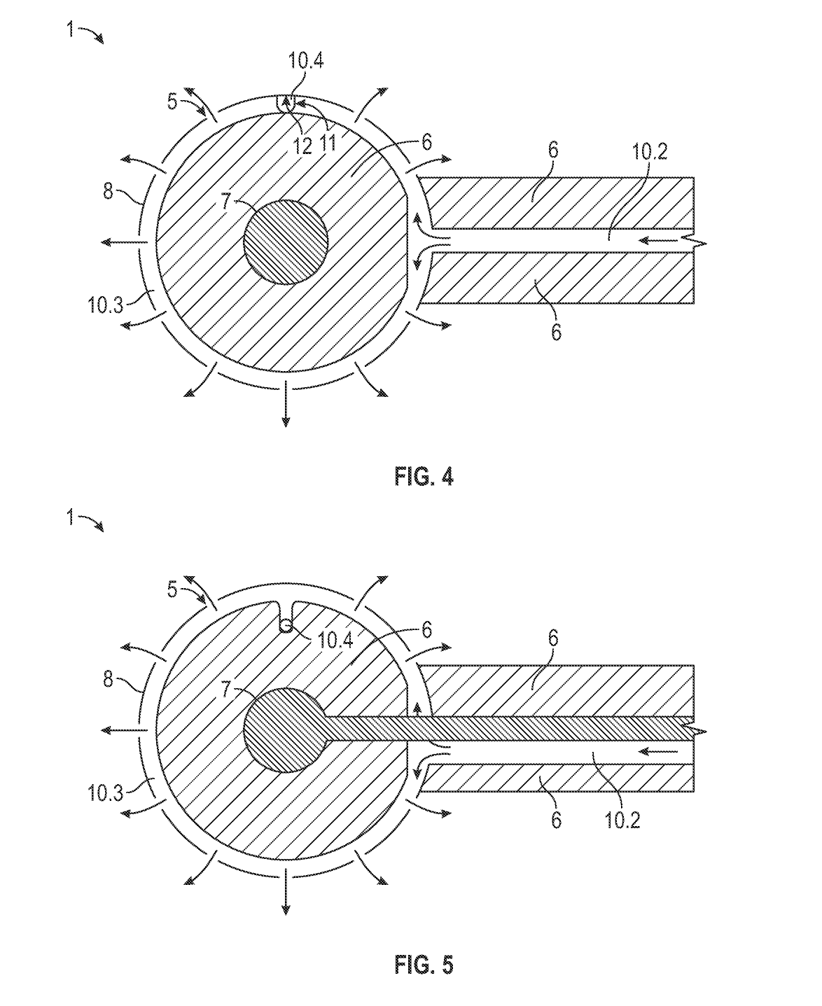

FIG. 5 shows a detail of a foam steering wheel 1 with a spoke air duct 10.2 abutting the support structure 7 according to an embodiment of the present invention in a sectional view through steering wheel rim 17 and spoke 18. In this embodiment as support structure 7, the steering wheel 1 in addition to the ring in the steering wheel rim 17 comprises a spoke element that is connected to the latter. The spoke air duct 10.2 is recessed as hollow space out of the foam element 6 in such a manner that a part of the hollow space cross section is formed by the spoke element of the support structure 7.

In addition to this difference to the embodiment according to FIG. 4, the embodiment according to FIG. 5 also comprises a differently configured steering wheel rim air duct 10.4. This steering wheel rim air duct 10.4 does not run on the surface of the foam element 6, but in its longitudinal extension is completely arranged within the foam element. The steering wheel rim air duct 10.4 in FIG. 5 also extends out of the drawing plane into the sheet.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A steering wheel with an active ventilation device for a motor vehicle, comprising;
a fan arrangement with fan, by which air is brought in through an air inlet opening of the steering wheel; and
an air duct that is configured to conduct the air to an air outlet opening of the steering wheel,
wherein the air ducts is formed as a hollow space in a foam element of the steering wheel.

2. The steering wheel according to claim 1, further comprising support structure, wherein the air within the steering wheel is conducted in an outside air duct that is outside the support structure.

3. The steering wheel according to claim 1, wherein a cross section of the hollow space is bounded in a first circumferential region by the foam element and in a second circumferential region by a support structure of the steering wheel.

4. The steering wheel according to claim 1, wherein the air duct formed as a macroscopic hollow space is spatially spaced at least in portions from a support structure of the steering wheel.

5. The steering wheel according to claim 1, wherein the air ducts based on a cross section through a steering wheel rim of the steering wheel has a substantially annular cross section.

6. The steering wheel according to claim 2, wherein the foam element is arranged substantially surrounding the support structure of the steering wheel,
and wherein the air ducts of the steering wheel are arranged in the foam element.

7. The steering wheel according to claim 1,
wherein the foam element comprises a recess, and
wherein the fan of the fan arrangement is arranged in the recess.

8. The steering wheel according to claim 1, wherein the fan of the fan arrangement is arranged in a hub of the steering wheel.

9. The steering wheel according to claim 1, wherein from the fan the air is conducted through the air duct to the air outlet opening arranged in a steering wheel rim of the steering wheel.

10. The steering wheel according to claim 1, wherein an outer boundary element of the steering wheel comprises a plurality of air outlet openings that are arranged on the outside of the steering wheel.

11. The steering wheel according to claim 1, wherein the air inlet opening comprises a protective device.

12. (canceled)

13. A method for producing a steering wheel with an active ventilation device, comprising:
producing a mold for forming a foam element of the steering wheel:
arranging a mold element—in the mold;
forming an air duct as hollow space in the foam element for conducting air; and
casting the foam element of the steering wheel with the air duct.

14. The method according to claim 13, wherein the mold element is arranged in such a manner to create the air duct during the casting at least in longitudinal portions running along a boundary surface of the foam element so that a cross section of the longitudinal portions is bounded by a foam mass of the foam element.

15. The steering wheel according to claim 1, wherein a cross section of the hollow space is bounded in a first circumferential region by the foam element and in a second circumferential region by an outer boundary element of the steering wheel.

16. The steering wheel according to claim 11, wherein the protective device is a protective grille.
